(19) United States
(12) Patent Application Publication
(10) Pub. No.: US 2004/0027355 A1
(43) Pub. Date: Feb. 12, 2004

(54) System and method for linking controlled vocabulary data

(76) Inventor: Songqiao Liu, Los Angeles, CA (US)

Correspondence Address: Marvin H. Kleinberg, KLEINBERG & LERNER, LLP, Suite 1080, 2049 Century Park East, Los Angeles, CA, 90067, US

(21) Appl. No.: 10/386,790

(22) Filed: Mar. 12, 2003

Related U.S. Application Data
(60) Provisional application No. 60/363,895, filed on Mar. 12, 2002.

(51) Int. Cl. G06F 13/28

(52) U.S. Cl. 345/533

(57) ABSTRACT

A method of linking controlled vocabulary data to a computer application includes the steps of invoking a command on a graphical user interface of the application to activate a controlled vocabulary display program which contains a controlled vocabulary, selecting terms of interest in the controlled vocabulary, closing said display program, passing data relating to said selected terms of interest to the computer application, and rendering the controlled vocabulary data in a display of the computer program.

### CROSS-REFERENCE TO RELATED APPLICATIONS

The present application is a continuation in part of U.S. provisional patent application serial No. 60/363,895, which is incorporated into the present application by this reference.

### BACKGROUND

1. Field of the Invention

The present invention relates to the field of information indexing and linking, and more particularly to a system and method of easily linking controlled vocabulary data to a variety of computer applications.

2. Prior Art

A thesaurus is tool which can be used in fields that have a need to describe numerous and various items in a precise and exact manner. For example, a thesaurus can be used by a museum to index the objects in its collection. A thesaurus identifies terms used in a particular field or area, and defines relationships between the terms. A thesaurus does not contain all possible terms that may be used in a particular field. Instead, a thesaurus uses a controlled vocabulary, which is a limited set of relevant terms that are used in a given field. A controlled vocabulary is a collection of descriptive terms which makes up the thesaurus. Controlled vocabularies can be used for purposes other than a thesaurus, including subject headings, classifications and other applications in the indexing genre

A major purpose of a controlled vocabulary and a thesaurus is to match the terms brought to the system by a researcher with the terms used by an indexer. Whenever there are alternative names for a type of item, a indexer will have to choose one to use for indexing, and provide an entry under each of the others saying what the preferred term is. For example, a library thesaurus may index all full-length works of fiction as “novels”. Then, someone who searches for “mysteries” must be told that they should look for “novels” instead. This is no problem if the two words are really synonyms, and even if they do differ slightly in meaning it may still be preferable to choose one and index everything under that. The thesaurus will therefore indicate synonyms in the controlled vocabulary for terms within the thesaurus.

A thesaurus will also describe other types of relationships between words. For example, a thesaurus will often organize terms in a hierarchical format. The term “novels” in the present example, can be a subset of the term “works of fiction” (which might also include “poems” and “short stories”). Thus, the thesaurus will specify where in the hierarchy the terms in the controlled vocabulary fall. Broader terms and lesser-included terms can be specified. Other types of relationships can also be specified by the thesaurus.

A problem arises when an indexer needs to actually use the thesaurus data to classify the items in a particular collection. In many instances, a controlled vocabulary will contain a large number of terms, and the indexer will not know all of them. In addition, the indexer will not be aware of all of the relationships between terms that are in the thesaurus. Thus, even if an indexer is aware of certain terms in the controlled vocabulary, he is likely to not be aware of how the thesaurus specifies the relationships between the different terms. For example, the indexer may not be aware that the thesaurus specifies “poetry” as a lesser included term for “works of fiction.”

Even if the indexer is aware of specific terms within a thesaurus, there does not presently exist an efficient and automatic method of linking controlled vocabulary data to a particular indexing program.

It is therefore a goal of the present invention to provide a system and method which will easily permit an indexer to search through the terms of a controlled vocabulary in a thesaurus.

It is another goal of the present invention to provide a system which will allow controlled vocabulary data to be linked to a wide range of different computer application programs.

### SUMMARY OF THE INVENTION

The present invention overcomes the limitations of the prior art by providing a method of linking controlled vocabulary data to a computer application. The method includes the steps of invoking a command on a graphical user interface of the application to activate a controlled vocabulary display program which contains a controlled vocabulary, selecting terms of interest in the thesaurus, closing said display program, passing data relating to said selected terms of interest to the computer application, and rendering the controlled vocabulary data in a display of the computer program.

### BRIEF DESCRIPTION OF THE DRAWINGS

FIG. 1 is a block diagram showing a general purpose computer system which can implement the method of the present invention.

FIG. 2 illustrates a representative display window of an existing computer program used to index data elements.

FIG. 3 is a logic diagram illustrating the main steps in the method of the present invention.

FIG. 4 illustrates the display window of FIG. 2 which has a command button added to the graphical user interface to allow a controlled vocabulary display window to be displayed.

FIG. 5 illustrates a sample controlled vocabulary display window used in the present invention.

FIG. 6 illustrates the display window of FIG. 4 which has selected terms from the controlled vocabulary of a integrated into an existing application.

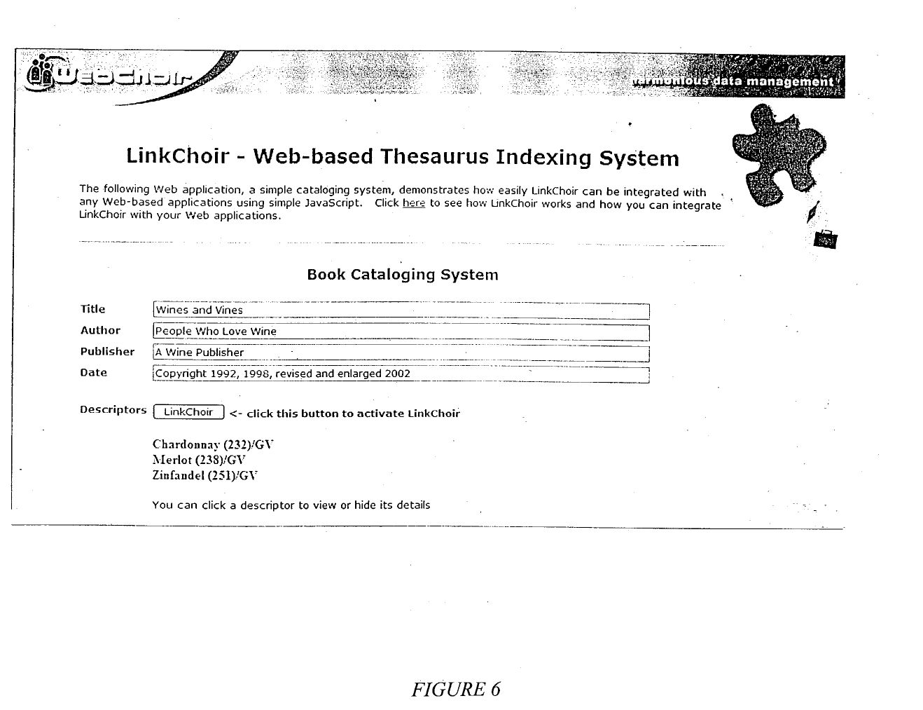

### DETAILED DESCRIPTION OF THE INVENTION

A system and method of linking controlled vocabulary data to a variety of different computer applications will be described. In the following description, specific method steps and procedures are described in order to give a more thorough understanding of the present invention. In other instances, well known elements such as the operating system and specific software functions are not described in detail so as not to obscure the present invention unnecessarily.

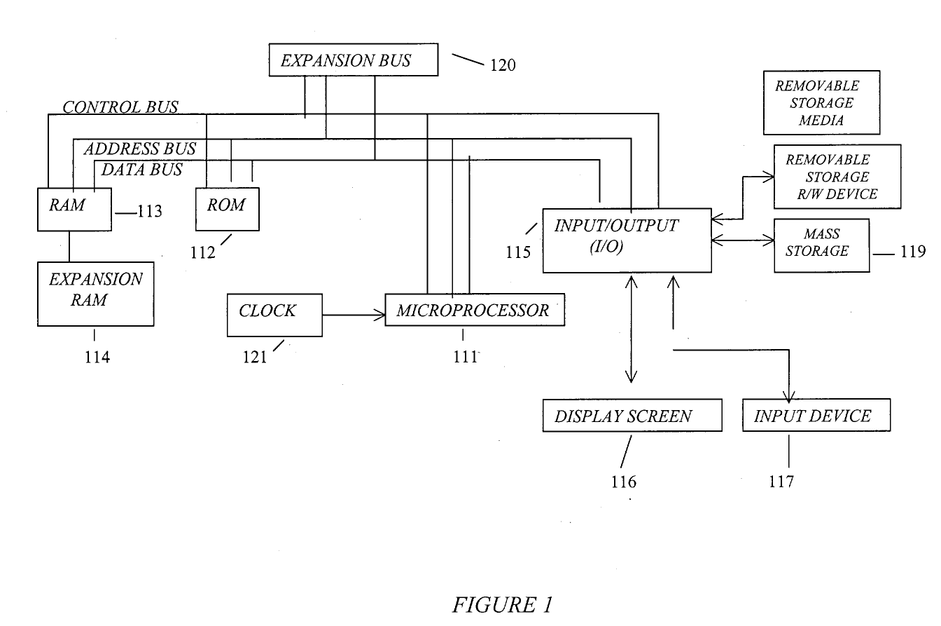

Referring first to FIG. 1, a block diagram of a general purpose computer system which can be used to implement the method of the present invention is illustrated. Specifically, FIG. 1 shows a general purpose computer system 150 for use in practicing the present invention. As shown in FIG. 1, computer system 110 includes a central processing unit (CPU) 111, read-only memory (ROM) 112, random access memory (RAM) 113, expansion RAM 145, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The thesaurus data which is stored in the present invention will be generally stored on mass storage device 119.

In operation, information is input into the computer system 110 by typing on a keyboard, manipulating a mouse or trackball, or “writing” on a tablet or on position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system or web server. Various other types of computers, however, may be used depending upon the size and complexity of the required tasks. Suitable computers include mainframe computers, multiprocessor computers and workstations. Typically, the program of the present invention will be stored on mass storage device 119 until a user of the computer system 111 initiates its operation. Portions of the program may then be transferred to RAM 113 while the program executes. Alternatively, the program of the present invention may reside in RAM 113 or ROM 112.

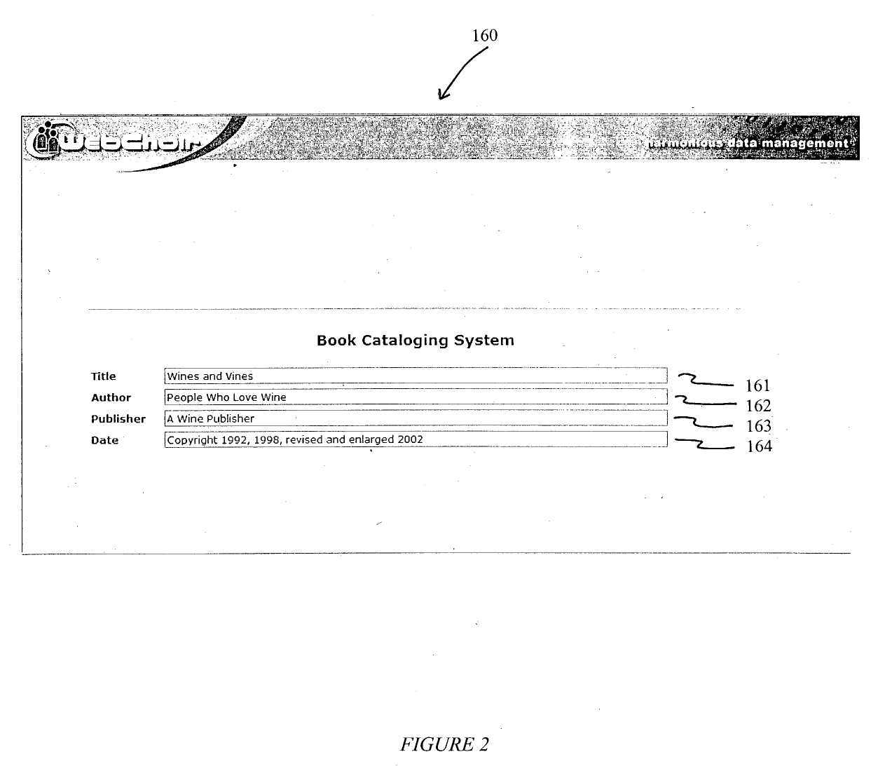

The present invention incorporates a method of linking controlled vocabulary data to a variety of computer applications which can be implemented on the general-purpose computer system described in FIG. 1. Referring next to FIG. 2, a logic diagram illustrating the main steps in the method of the present invention is shown. The user will typically need to have access to thesaurus and controlled vocabulary data when he is working in an existing computer application. In most instances, the user will be adding descriptive terms from the controlled vocabulary to individual data records stored in a larger database.

The preferred embodiment of the method of the preset invention is intended to be used with computer applications which are web-based. The preferred embodiment utilizes the JavaScipt language to effect the operation of various elements of the invention on the computer system. It will be apparent to those of skill in the art that the present invention can be practiced in connection with other types of computer programs, and in other programming environments. For example, the present invention can be implemented in a client-server environment. In instances where the computer system is not compatible with JavaScript, other programming languages can be used.

Referring next to FIG. 2, a representative display window 160 of a data-cataloging system is shown. It is anticipated that the present invention will be used with existing computer applications such as digital asset management systems, library cataloging systems, museum collection management systems and the like. FIG. 2 illustrates a hypothetical data entry window for a book cataloging system. With FIG. 2, an indexer needs to link specific terms from a thesaurus which will be used to describe the book “Wines and Vines” that is used as an example in this case. The display window 160 includes data fields 161, 162, 163 and 164 which store factual data concerning the book. The present invention allows additional descriptive terms (also called descriptors) from a controlled vocabulary such as that used in a thesaurus to be added to the display window 160 in a seamless and integrated manner.

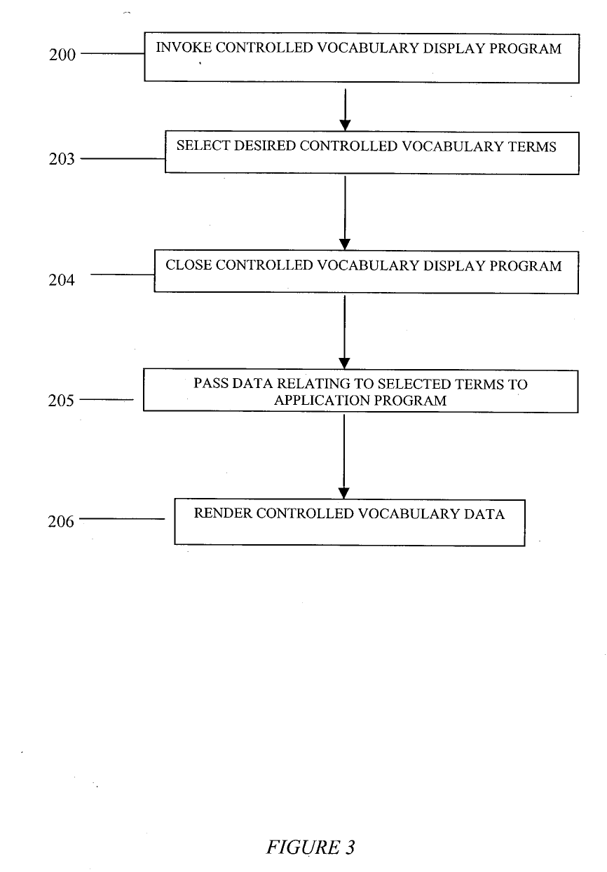

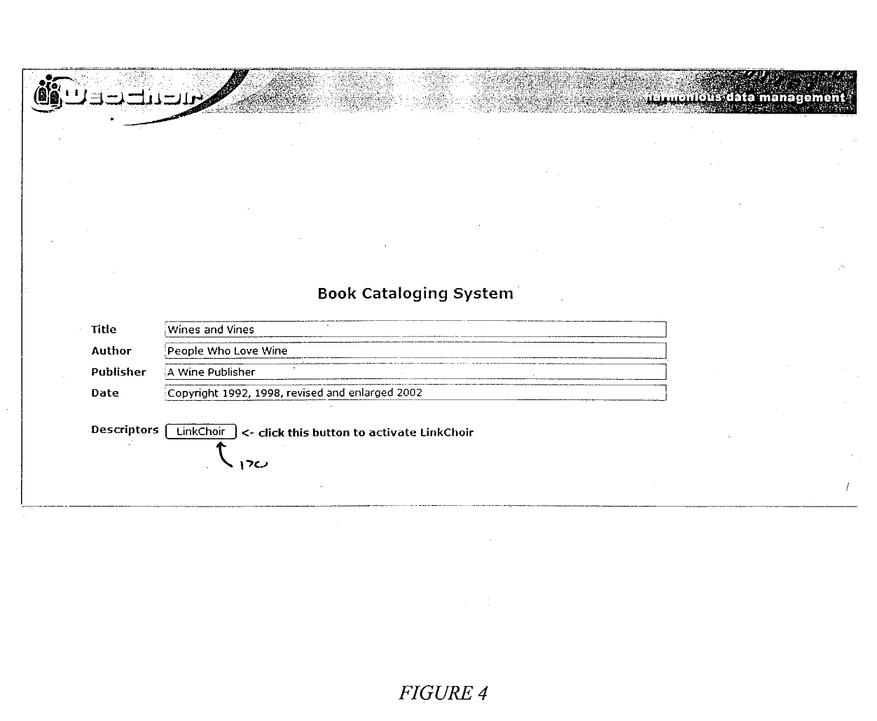

The major steps in the present invention are illustrated in FIG. 3. The first step 200 is to activate a controlled vocabulary display program. This is accomplished by invoking a command on the graphical user interface (GUI) of the display window 160 of the application. Because the present invention is web-based, the existing application can be modified to include a GUI command which will activate the display of controlled vocabulary data. FIG. 4 illustrates the representative display screen of FIG. 2 which has been modified to include a GUI button 170 which, when invoked, causes the controlled vocabulary display window to be activated. The button is added to the display window 160 in the preferred embodiment by adding suitable JavaScript commands.

It will be apparent to those of skill in the art that various different methods and strategies can be used to cause the controlled vocabulary display program to be activated. The button displayed in FIG. 4 is by no means the only method that can be used. Various different drop-down menus, dialog boxes and the like can be used with equal effectiveness. A hyperlink can also be used. The command does not need to be limited to an element of a GUI. For example, in the Windows operating system, the command could be invoked through a DOS command-line prompt. The manner of implementing these commands will be well-known to those of skill in the art.

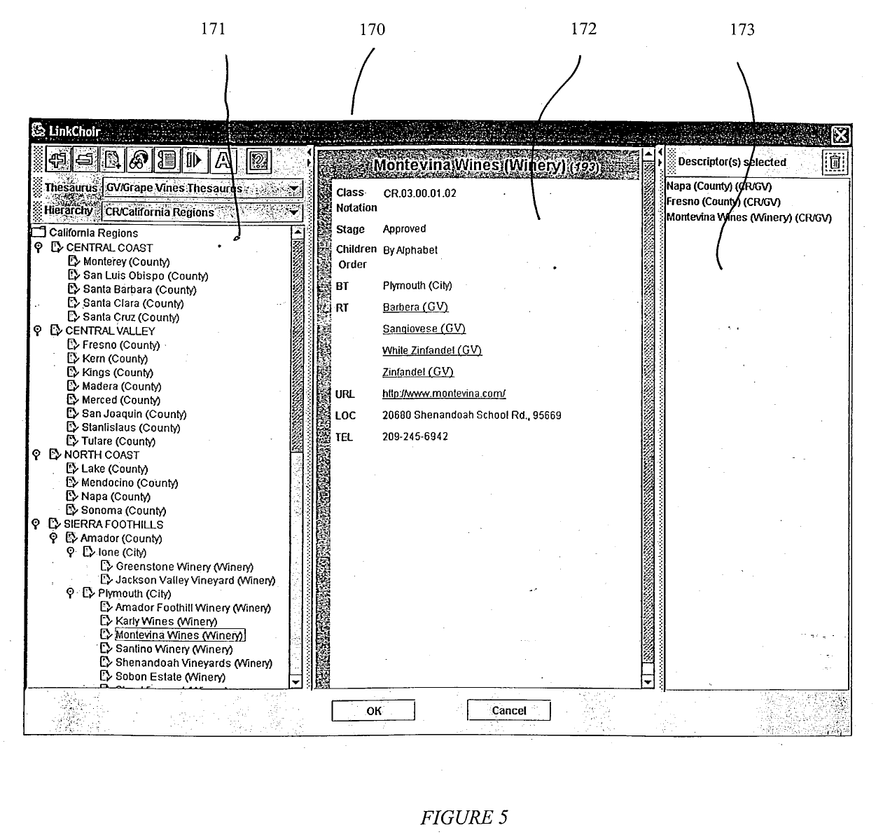

After the command is invoked, the controlled vocabulary data is displayed in a separate window of the GUI. FIG. 5 illustrates a sample controlled vocabulary display window used in the present invention. In FIG. 5, there is shown a window 170 of a GUI with three display areas 171, 172 and 173. Display area 171 contains all of the terms of the controlled vocabulary which is being used. In the usual case, the elements of the controlled vocabulary used in a thesaurus will be organized in a hierarchical structure. Thus, FIG. 5 shows the thesaurus terms displayed in the same hierarchical manner in display area 171. The controlled vocabulary terms are not limited to being displayed in the hierarchical format. In an alternative embodiment, the thesaurus terms are organized alphabetically. Other arrangements can be used with equal effectiveness, such as string length or chronologically (e.g., by date of creation).

The user in the next step 203 of FIG. 3 selects the terms from the controlled vocabulary that are desired to be used in the indexing processes. The user selects the term of interest by highlighting the term using standard navigation techniques of the GUI. For example, the user can use a point and click device, such as a mouse or trackball. Equivalently, the user can employ keyboard commands to highlight the selected term. In FIG. 5, the selected term 124 is “Montevina Wines” which is a term in the controlled vocabulary of the thesaurus of the present example. The selected terms are listed in display area 173.

Once the term of interest has been selected, (step 203) the computer system will retrieve the data file for the selected term and display the data in display area 172 of window 170. Display area 172 contains the detailed thesaurus data regarding the term which has been selected. All of the related words which are defined in the thesaurus are displayed, and their relationships (e.g., synonyms, used for, related terms) to the selected terms are included. A method of retrieving thesaurus data which is used in the present invention is described in co-pending patent application serial number ______. Therein is described a method which can retrieve XML data files. There is a separate data file stored in either RAM 113 or mass storage device 119 of the computer system for each term in the thesaurus. The use of XML data eliminates the need for a separate commercial database management system.

After the desired terms have been selected from the controlled vocabulary, the user will exit the controlled vocabulary display program and close the display window 170. This is shown as step 204 in FIG. 3. When the display window 170 is closed, the controlled vocabulary data relating to the selected terms is passed to the application which is being used to index the particular item in step 205.

This can be accomplished by adding a JavaScript function to the invoking Applet Close event in the HTML HEAD section.

function termLinkerClosed (action) {

for (var i = 0;

I<document.termlinker.getDescriptorCount( ); i++) {

document.termlinker.locateDescriptor(i)
descriptor[i].innerHTML =
document.termlinker.getDescriptorLabel
descriptorNode[i].innerHTML =

document.termlinker.getDescriptorNode

( )

}

To make the concept clear, this function is simplified to obtain values for only descriptor and node. Based on his needs, however, the indexer can obtain values of any references a descriptor might have, such as scope note, broader terms, synonyms, and related terms, as easily as obtaining the values of a descriptor using similar JavaScript. For example, use the function “document.termlinker.getRTLabel ( )” to obtain the value of related terms and the function “document.termlinker.getRTNode ( )” to obtain the unique identifier of related terms.

After the descriptors have been passed to the application program, they are rendered in a display window of the computer program, and made available to the indexer for further manipulation, according to the limitations of the computer program being used. This corresponds to step 206 in FIG. 3. For example, the indexer may then be able to save, delete or otherwise manipulate the descriptors.

The present invention has been described in connection with a prior art computer application program which can be used to index items in a collection. It will be apparent to those of skill in the art that the method of the present invention is not limited to merely an indexing application. The present invention can be used with virtually any type of application that is web-based. The GUI commands that are used to invoke the controlled vocabulary display program can be embedded into a wide variety of different applications.

It will be apparent to those of skill in the art that the steps in the foregoing method do not need to be performed in the exact order in which they have been described. The order may be varied without departing from the overall scope of the present invention. For example, all of the controlled vocabulary terms of interest can be selected before the display window 170 is closed. Then all of the descriptive terms are passed through to the application at the same time, as opposed to sequentially. In an alternative embodiment, the method is modified such that the controlled vocabulary display window does not need to be closed each time. Suitable commands are added to the GUI to automatically pass the controlled vocabulary data to the application program after terms from the controlled vocabulary are selected.

Accordingly, a system and method of linking controlled vocabulary data to a variety of computer applications has been described. It is to be understood that the foregoing description has been made with respect to specific embodiments thereof for illustrative purposes only. The overall scope of the present invention is limited only by the following claims.

What is claimed is:

1. A method of linking controlled vocabulary data to a computer application program comprising the steps of:
(a) invoking a command on a graphical user interface to activate a controlled vocabulary display program containing a controlled vocabulary;
(b) selecting terms of interest in the controlled vocabulary;
(c) exiting said display program;
(d) passing data relating to said selected terms of interest to the computer application;
(e) rendering the controlled vocabulary data in a display of the computer application program.
